(19) United States
(12) Patent Application Publication
(10) Pub. No.: US 2008/0085432 A1
(43) Pub. Date: Apr. 10, 2008

(54) Solid oxide fuel cell module and control method thereof

(76) Inventors: Akihiko Noie, Hitachinaka (JP); Nariyoshi Kobayashi, Hitachinaka (JP); Hiromi Tokoi, Tokai (JP); Kazuo Takahashi, Hitachiota (JP); Tadashi Yoshida, Hitachi (JP); Shin Takahashi, Hitachi (JP); Akira Gunji, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/657,690

(22) Filed: Jan. 25, 2007

(30) Foreign Application Priority Data
Oct. 10, 2006 (JP) 2006-276609

(51) Int. Cl. H01M 8/04

(52) U.S. Cl. 429/14; 429/13; 429/26

(57) ABSTRACT

In a solid oxide fuel cell module (1) incorporating a burner (6) not only in an oxidizer side burner (5) of the module (1) but also in a fuel side, directly heating from both sides by a combustion gas, and starting for a short time, a combustion state of the fuel side burner is kept well, and a short-time start is securely achieved. A cooling piping (17) is provided in a burner main body (61) and a premixing chamber (62) of the fuel side burner (6), and is connected to a heat recovery system (16) so as to supply a cooling medium, thereby cooling the fuel side burner (6). Further, a heat held by the cooling medium is recovered by a heat exchanger (18) connected to an outlet side of the heat recovery system (16). A back fire (an abnormal combustion) of the burner is prevented, the module is uniformly heated, and a secure short-time start is achieved, by cooling the fuel side burner (6) so as to adjust temperature. Further, a combined efficiency of the module is improved by utilizing the recovered surplus heat.

### BACKGROUND OF THE INVENTION

1. Field of the Invention

The present invention relates to a solid oxide fuel cell module provided with a container storing a plurality of unit cells reacting a fuel and an oxide so as to pick up an electricity, and a control method thereof.

2. Description of Related Art

Since a power generation temperature of a solid oxide fuel cell module is a high temperature, about 800 to 1000° C., it is necessary to rise up the temperature to a temperature capable of generating power. In recent years, there is attempted to shorten a starting time of the module, for a practical application of the solid oxide fuel module. There is required a module structure, an operating method or the like for making it possible to start the module for a short time.

As a module structure for uniformly heating and temperature rising a fuel side (also called as an anode side) and an oxidizer side (also called as a cathode side) of the solid oxide fuel cell module so as to start for a short time, there has been proposed a structure in which a burner is incorporated not only in the oxidizer side but also in the fuel side, as shown in patent document 1 (JP-A-2001-155754). In accordance with this module structure, it is possible to uniformly heat the module by the burner simultaneously from the fuel side and the oxidizer side, and it is possible to start the module for a short time.

Further, in patent document 2 (JP-A-2002-31307), for example, there is disclosed cooling a premixed gas and an inner side of a fuel chamber, in a fluid heating apparatus having a cooling fluid circulating in an inner portion of a fuel cell as a heated fluid.

Further, in patent document 3 (JP-A-2006-12593), there is disclosed provision of a cooling means in an evaporation portion, in a reforming device provided with the evaporation portion evaporating a liquid fuel, and a burner burning the evaporated fuel.

In the solid oxide fuel cell module in which the burner is incorporated not only in the oxidizer side but also in the fuel side, disclosed in the patent document 1, existence of the following problems becomes apparent.

In the burners in the oxidizer side and the fuel side incorporated in the solid oxide fuel cell module, a periphery thereof is surrounded by a heat insulating material, a temperature becomes higher in comparison with a case of a simple burner. Particularly, since a hydrogen fuel within a fuel container can not be oxidized in the fuel side burner supplying the hydrogen fuel to the fuel cell, an amount of air is limited at a time of combustion, a cooling effect by the air is small, and the temperature tends to rise up. A fuel premixed air obtained by previously mixing the fuel and the air is supplied to the fuel side burner, however, in the case that the temperature of the burner rises up so as to get over an ignition temperature of the fuel, the premixed air is ignited and is burned in a piping and a premixed portion. Accordingly, the burner can not be burned normally, it is impossible to uniformly heat, and it is hard to start the module for a short time. Further, this structure is not preferable in view of a safety at a time of starting the module.

### BRIEF SUMMARY OF THE INVENTION

An object of the present invention is to provide a module structure achieving a secure short-time start of a module, in a solid oxide fuel cell module in which burners are incorporated in both of an oxidizer side and a fuel side.

The other object of the present invention is to provide a control method of a solid oxide fuel cell module for keeping an incorporated burner in a normal combustion state and achieving a secure short-time start of a module, in the control method of the solid oxide fuel cell module directly heating a hydrogen fuel or the like.

In accordance with one aspect of the present invention, there is provided a solid oxide fuel cell module comprising:

an oxidizer side burner heating an oxidizer within an oxidizer container; and

a fuel side burner heating a fuel within a fuel container,

wherein a cooling means keeping a temperature of the fuel within the fuel container within a predetermined range is arranged in the fuel side burner.

In accordance with a desirable aspect of the present invention, the cooling means is structured such as to cool a fuel premixing chamber of the burner.

In accordance with the other desirable aspect of the present invention, the cooling means is structured such that a flow path of a heating medium is formed in such a manner as to cool a burner main body of the fuel side burner.

In accordance with the other aspect of the present invention, the module is provided with a heat recovery means recovering a heat from the heating medium heated by cooling the fuel side burner.

In accordance with a desirable aspect of the present invention, the heat recovery means utilizes the recovered heat (1) as a heat source of a hot water supply equipment, (2) for supplying to an exhaust heat recovery boiler and driving a vaporizing type refrigerator, (3) for supplying to a turbine and driving a power generator, or (4) as a heat source for reforming the fuel supplied to the fuel side or generating a water vapor.

In accordance with the desirable aspect of the present invention, it is possible to regulate the temperature of the burner fuel premixed air, prevent an abnormal combustion of the fuel premixed air, keep the combustion state of the burner normal, and uniformly heat the module, whereby it is possible to achieve a secure short-time (for example, within one hour) start of the solid oxide fuel cell.

In accordance with the other desirable aspect of the present invention, it is possible to recover the heat from the heating medium heated by the burner and/or the cooling operation of the burner fuel premixed air so as to effectively utilize.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a cross sectional view showing a solid oxide fuel cell module provided with a cooling means in a premixing chamber of a fuel side burner and a block diagram of a heat recovery system in accordance with a first embodiment of the present invention;

FIG. 2 is a cross sectional view of details of the fuel side burner portion in the first embodiment of the present invention;

FIG. 3 is a solid oxide fuel cell module provided with a cooling means in a premixing chamber of a fuel side burner in accordance with a second embodiment of the present invention;

FIG. 4 is a cross sectional view of details of the fuel side burner portion in the second embodiment of the present invention;

FIG. 5 is a cross sectional view and a block diagram showing a solid oxide fuel cell module provided with a heat recovery system in accordance with a third embodiment of the present invention;

FIG. 6 is a cross sectional view and a block diagram showing a solid oxide fuel cell module provided with a heat recovery system in accordance with a fourth embodiment of the present invention;

FIG. 7 is a cross sectional view and a block diagram showing a solid oxide fuel cell module provided with a heat recovery system in accordance with a fifth embodiment of the present invention; and

FIG. 8 is a cross sectional view and a block diagram showing a solid oxide fuel cell module provided with a heat recovery system in accordance with a sixth embodiment of the present invention.

### DETAILED DESCRIPTION OF THE INVENTION

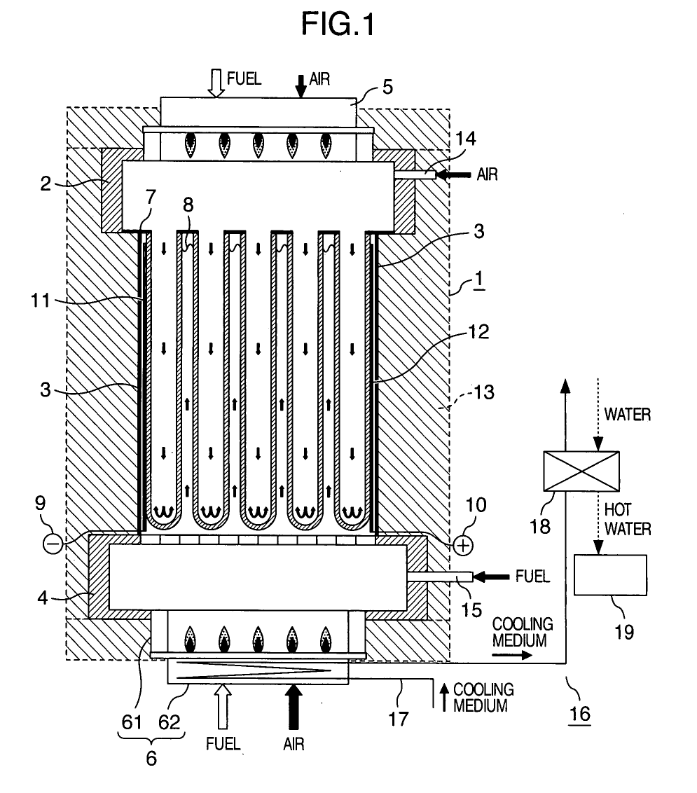

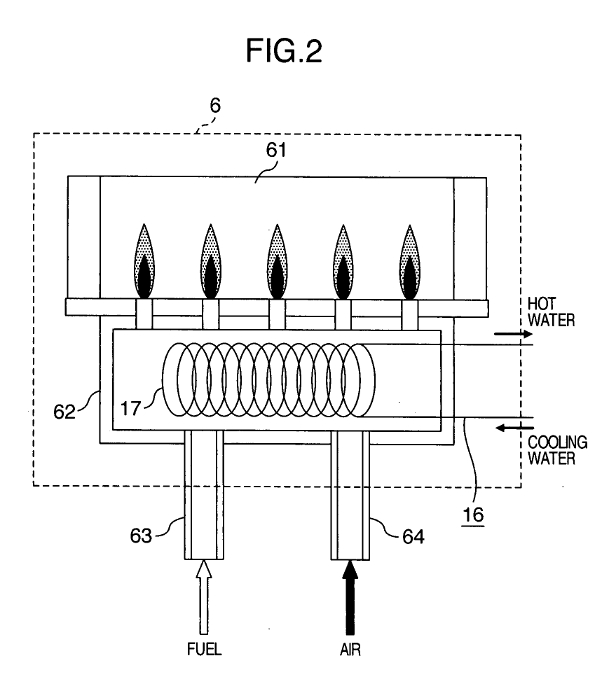

A description will be given of a first embodiment in accordance with the present invention with reference to FIGS. 1 and 2.

FIG. 1 is a cross sectional view showing a solid oxide fuel cell module provided with a cooling means in a premixing chamber of a fuel side burner and a block diagram of a heat recovery system in accordance with a first embodiment of the present invention. An operating temperature of the solid oxide fuel cell module is about 800° C. to 1000° C.

A solid oxide fuel cell module 1 is constituted by an oxidizer container 2, a cell container 3 and a fuel container 4, an oxidizer side burner 5 is attached to the oxidizer container 2, and a fuel side burner 6 is attached to the fuel container 4. A plurality of unit cells 7 are stored in an inner portion of the cell container 3, and each of the unit cells is electrically connected by an electric conductor 8. Both ends of the module are provided with a cathode electrode 9 and an anode electrode 10 for picking up an electric current generated in the module, and these electrodes are connected to the unit cells 7 via a cathode collecting electrode 11 and an anode collecting electrode 12.

The cell container 3, a whole of the oxidizer container 2 and the fuel container 4 sandwiching it therebetween, and a whole and a part of the oxidizer side burner 5 and the fuel side burner 6 are covered by a heat insulating material 13.

At a time of starting the solid oxide fuel cell module 1, the fuel and the air are respectively supplied to the oxidizer side burner 5 and the fuel side burner 6 so as to be premixed, and are burned by the burner, and the cell is directly heated and temperature risen by the combustion gas. The fuel side burner 6 is constituted by a burner main body 61 and a premixing chamber 62, and the fuel and the air are introduced from a burner fuel piping 63 and a burner air piping 64 as shown in FIG. 2.

After the unit cells 7 within the module reach the operating temperature, the air is fed to the oxidizer container 2 via an air supply pipe 14, and is supplied to the cathode collecting electrode 11 of the unit cell 7. Further, the fuel for generating power is fed to the fuel container 4 from the fuel supply pipe 15, and is supplied to the anode collecting electrode 12 of the unit cell 7. An electric current is generated in the unit cell 7 in accordance with an electrochemical reaction. The electric current generated in the whole of the module is picked up from the cathode electrode 9 and the anode electrode 10.

FIG. 1 shows an embodiment provided with a heat recovery system 16 utilizing a heat recovered from the fuel side burner 6 of the solid oxide fuel cell module 1 for a hot water supply. The embodiment puts a cooling medium (a heating medium) heated by a premixing chamber 62 of the fuel side burner 6 through a heat exchanger 18 via a piping 17, and heats up a water flowed so as to face to a flow of the cooling medium by the heat of the heating medium. The heated hot water is stored in a hot water reservoir tank 19, and is utilized for the hot water supply.

FIG. 2 is a cross sectional view of details of the fuel side burner portion in the first embodiment of the present invention. A burner fuel piping 63 and a burner air piping 64 are connected to the premixing chamber 62 of the fuel side burner 6, the fuel and the air are respectively supplied at a fixed rate, are supplied to a burner main body 61 of the fuel side burner 6 after being mixed in the premixing chamber 62, and are burnt. A spiral piping 17 is installed within the premising chamber 62, and is connected to the heat recovery system 16. An outlet side of the heat recovery system 16 is connected to the heat exchanger 18 in FIG. 1.

At a time of starting the solid oxide fuel cell module 1, the premixed air-fuel mixture within the premixing chamber 62 is cooled by supplying the cooling water to the piping 17 installed within the premixing chamber 62 through the heat recovery system 16 at the same time of starting the combustion of the fuel side burner 6, the premixed air-fuel mixture within the premixing chamber 62 is cooled, and a temperature rise is suppressed. Accordingly, it is possible to prevent the burner fuel premixed air from burning within the premixing chamber 62, and it is possible to uniformly heat the module by the fuel side burner 6 and the oxidizer side burner 5. Therefore, it is possible to achieve a secure reduction of starting time of the solid oxide fuel cell module 1.

Further, a combined efficiency of the module is improved by recovering the heat from the water heated by the cooling of the premixed air-fuel mixture within the premixing chamber 62 by the heat exchanger 18 connected to the outlet of the heat recovery system 16 so as to utilize.

As mentioned above, in this embodiment, it is possible to keep the temperature of the fuel within the fuel container 4 to a desired temperature 700° C. to 750° C. by regulating a flow rate of the water flowed to the heating medium and the heat exchanger, and it is possible to achieve a secure start of the solid oxide fuel cell module 1 for a short time. Further, it is possible to supply the hot water having a necessary temperature while keeping the temperature of the fuel within the fuel container 4 within the desired value mentioned above, it is unnecessary to reheat at a time of supplying the hot water, it is possible to effectively utilize the heat recovered from the burner, and it is possible to intend to improve a heat efficiency of the solid oxide cell module 1.

In the solid oxide cell module 1, the burner is incorporated for rising up the temperature of the module, however, the heat recovery from the burner has not been executed. On the contrary, in accordance with the present embodiment, there can be obtained an excellent effect that it is possible to effectively utilize a surplus heat from the fuel side burner 6 obtained for achieving a secure short-time start, as well as it is possible to prevent an overheat of the built-in fuel side burner 6, it is possible to keep the normal combustion state, and it is possible to achieve a secure short-time start.

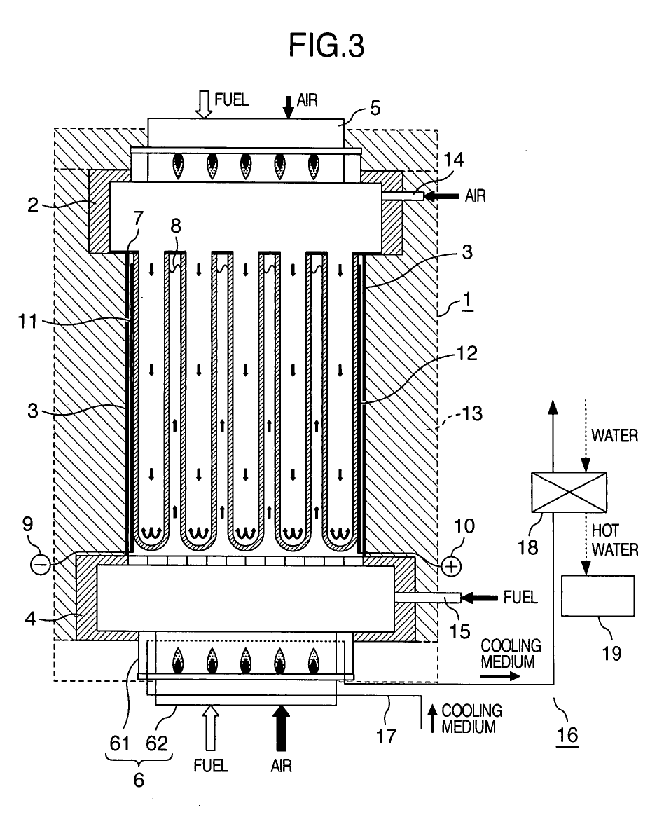

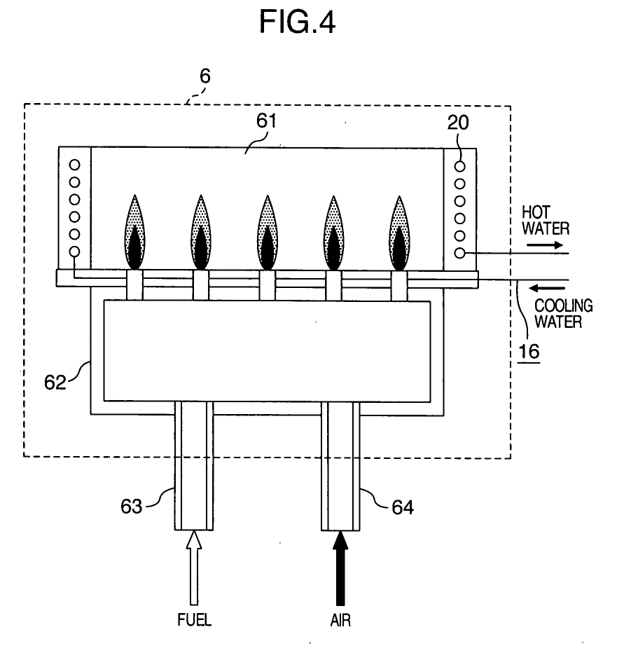

FIGS. 3 and 4 are cross sectional views showing a solid oxide fuel cell module provided with a cooling means in a premixing chamber of a fuel side burner in accordance with a second embodiment of the present invention. FIG. 3 shows a solid oxide fuel cell module 1 provided with a cooling means in the burner main body 61 of the fuel side burner 6 of the module. The module structure in accordance with the second embodiment is the same as the first embodiment except the cooling portion of the fuel side burner 6, as shown in FIG. 3, and an overlapping description will be omitted.

Detailed structure of the fuel side burner 6 in accordance with the second embodiment will be shown in FIG. 4. In the second embodiment, a cooling water path 20 is provided in a wall surface of the burner main body 61 of the fuel side burner 6, and the cooling water path 20 is connected to the heat recovery system 16. An outlet side of the heat recovery system 16 is connected to the heat exchanger 18 in the same manner as the first embodiment.

In this second embodiment, in the same manner as the first embodiment, at a time of starting the solid oxide fuel cell module 1, the cooling water is supplied to the cooling water path 20 provided in the fuel side burner main body 61 through the heat recovery system 16, at the same time of starting the combustion of the fuel side burner 6.

Accordingly, the fuel side burner 6 is cooled, and the temperature rise of the premixed air-fuel mixture heated by the burner is suppressed. As a result, in the same manner as the first embodiment, it is possible to prevent the burner fuel premixed air-fuel mixture from burning within the premixing chamber 62, and the module 1 can be uniformly heated by the fuel side burner 6 and the oxidizer side burner 5. Accordingly, it is possible to shorten the starting time of the solid oxide fuel cell module 1.

Both of the first and second embodiments use the water for cooling the burner 6 (the burner main body 61 and/or the burner fuel premixing chamber 62), and are particularly effective due to a great cooling effect in the case that it is intended to shorten the starting time of the module 1.

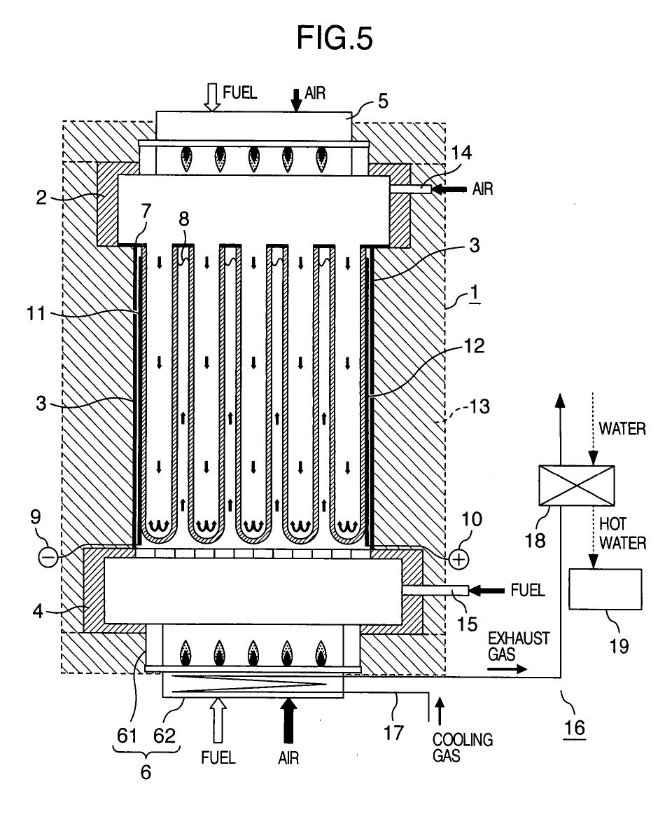

FIG. 5 is a cross sectional view and a block diagram showing a solid oxide fuel cell module provided with a heat recovery system in accordance with a third embodiment of the present invention. This embodiment shows an example which employs a gas for cooling the premixing chamber 62 of the fuel side burner 6.

A structure of the module 1 the same as the first embodiment. It is possible to suppress a temperature rise of the premixed air-fuel mixture so as to uniformly heat the module by employing the gas for the heating medium cooling the premixing chamber 62. Accordingly, it is possible to shorten the starting time of the module 1 in the same manner as the first and second embodiments.

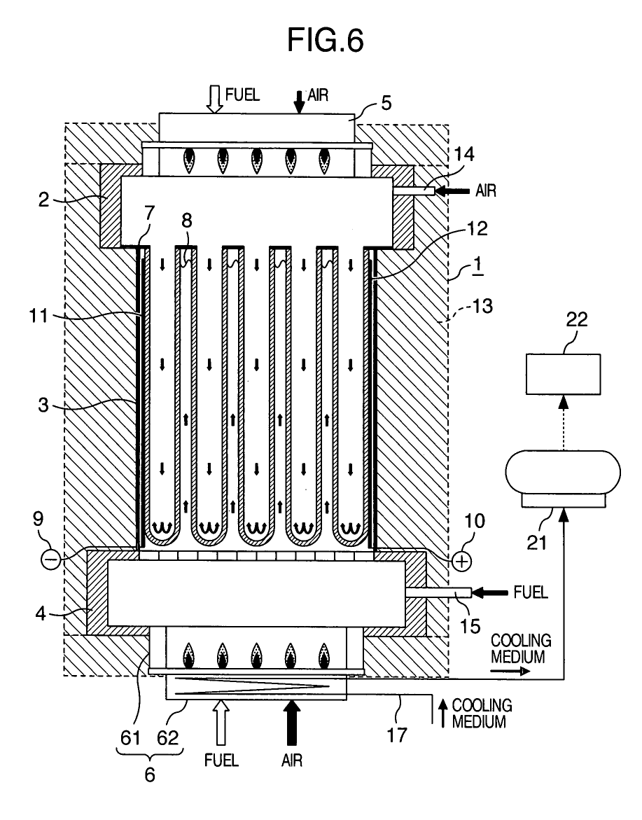

FIG. 6 is a cross sectional view and a block diagram showing a solid oxide fuel cell module provided with a heat recovery system in accordance with a fourth embodiment of the present invention. This drawing shows an embodiment utilizing a heat recovered from the premixing chamber 62 of the fuel side burner 6 of the solid oxide fuel cell module 1 for the hot water supply. A vapor is generated by putting a heating medium (a cooling medium) heated by the heat of the premixing chamber 62 of the fuel side burner 6 through an exhaust heat recovery boiler 21. The generated vapor is supplied to an evaporation type refrigerator 22 so as to operate the refrigerator 22.

In accordance with the structure of the present embodiment, it is possible to utilize the heat recovered from the premixing chamber 62 of the fuel side burner 6 as an energy source of the refrigerator 22, and it is possible to intend to improve a heat efficiency of the solid oxide fuel cell module 1. In the present embodiment, it is also possible to effectively utilize the heat from the fuel side burner 6.

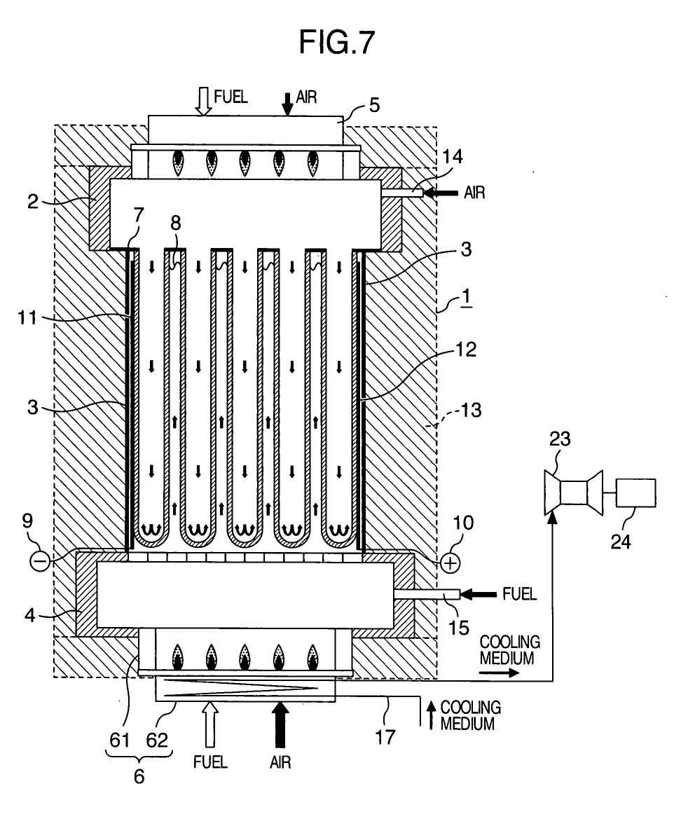

FIG. 7 is a cross sectional view and a block diagram showing a solid oxide fuel cell module provided with a heat recovery system in accordance with a fifth embodiment of the present invention. This drawing shows an embodiment utilizing a heat recovered from the burner of the solid oxide fuel cell module 1 as a power source. The heating medium heated by the heat of the burner is supplied to a turbine 104, a turbine is rotated, and a power generation is executed by a power generator 107 directly coupled thereto. In the present embodiment, it is possible to pick up the heat recovered by the burner as the power source. Accordingly, it is possible to intend to improve a heat efficiency of the solid oxide fuel cell module. Even in the present embodiment, it is possible to effectively utilize the heat from the burner portion.

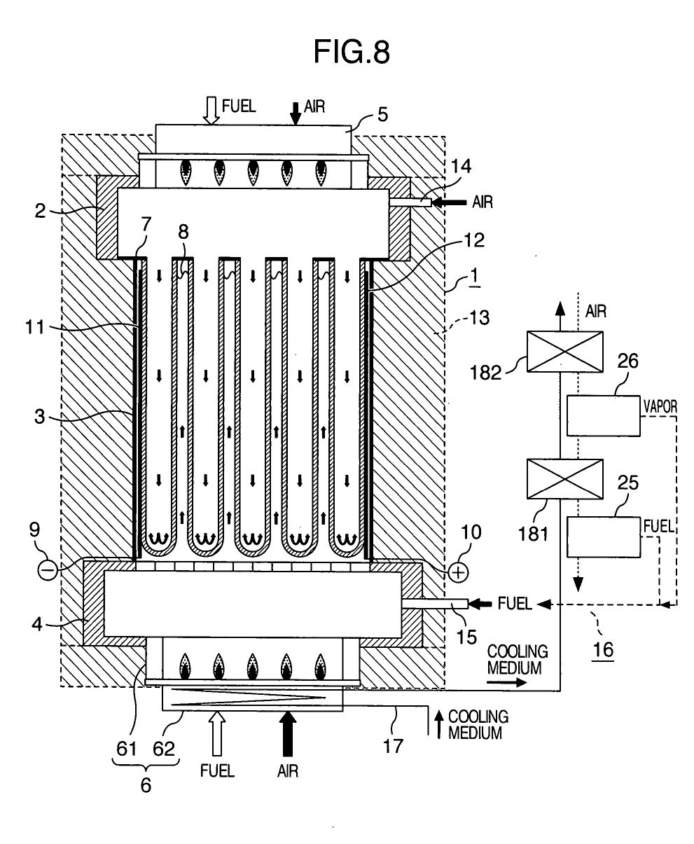

FIG. 8 is a cross sectional view and a block diagram showing a solid oxide fuel cell module provided with a heat recovery system in accordance with a sixth embodiment of the present invention. This drawing shows an embodiment utilizing a heat recovered from the burner 6 of the solid oxide fuel cell module 1 for reforming the fuel supplied to the fuel container 4 of the solid oxide fuel cell and generating a vapor. The reforming of the fuel and the generation of the vapor are generated by putting the heating medium (the cooling medium) heated by the fuel side burner 6 through heat exchangers 181 and 182, flowing the air in an opposing manner, and circulating the heated air through a reformer 25 and an evaporator 26. The power generation as the fuel cell is executed by supplying the fuel after being reformed and the generated vapor to the fuel container 4 of the solid oxide fuel cell module 1. Accordingly, it is possible to effectively utilize a surplus heat recovered from the fuel side burner 6 as an energy source for reforming the fuel and generating the vapor.

In accordance with the embodiments of the heat recovery system 16 in FIGS. 1 and 6 to 8, it is possible to effectively utilize the heat from the fuel side burner of the solid oxide fuel cell which is not effectively utilized, and it is possible to intend to improve a heat efficiency of the solid oxide fuel cell. As a utilized end, the heat is utilized for the hot water supply, as the energy source of the refrigeration, as the power of the power generator, or for reforming the fuel and generating the vapor required for power generation, in correspondence to the used condition of the user.

In accordance with the embodiments of the present invention mentioned above, it is possible to achieve both of a reduction of the starting time of the module and an improvement of the combined efficiency, by recovering the heat as well as cooling the fuel side burner of the solid oxide fuel cell and regulating the temperature.

It will be understood by those skilled in the art that the foregoing description has been made on the embodiments of the invention and that various changes and modifications may be made in the invention without departing from the spirit of the invention and the scope of the appended claims.

1. A solid oxide fuel cell module comprising:
a fuel container to which a fuel is supplied from an external portion;
an oxidizer container to which an oxidizer is supplied from an external portion;
a cell container storing a plurality of unit cells reacting the fuel from said fuel container with the oxidizer from said oxidizer container so as to pick up an electricity;
an oxidizer side burner heating the oxidizer within said oxidizer container; and
a fuel side burner heating the fuel within said fuel container,
wherein a cooling means keeping a temperature of the fuel within said fuel container within a predetermined range is arranged in said fuel side burner.

2. A solid oxide fuel cell module as claimed in claim 1, wherein said fuel side burner is provided with a burner main body, and a burner fuel premixing chamber mixing the fuel and the air introduced to the burner main body, and said cooling means is structured such as to cool said burner fuel premixing chamber.

3. A solid oxide fuel cell module as claimed in claim 1, wherein said fuel side burner is provided with a burner main body, and a burner fuel premixing chamber mixing the fuel and the air introduced to the burner main body, and said cooling means is structured such as to cool said burner main body.

4. A solid oxide fuel cell module as claimed in claim 1, wherein said cooling means is provided with a flow path of a heating medium passing through said fuel side burner.

5. A solid oxide fuel cell module as claimed in claim 1, wherein the solid oxide fuel module is provided with a heat recovery means recovering a heat from a heating medium heated by cooling said fuel side burner.

6. A solid oxide fuel cell module as claimed in claim 5, wherein said heat recovery means is provided with a heat exchanger.

7. A solid oxide fuel cell module as claimed in claim 4, wherein said heating medium employs a water, an air or an inert gas.

8. A solid oxide fuel cell module as claimed in claim 1, wherein the solid oxide fuel cell module is provided with a heat recovery system utilizing the heat recovered from said fuel side burner by said cooling means as a heat and a power.

9. A solid oxide fuel cell module as claimed in claim 1, wherein the solid oxide fuel cell module is provided with a heat recovery system utilizing the heat recovered from said fuel side burner by said cooling means as a heat source of a hot water supply equipment.

10. A solid oxide fuel cell module as claimed in claim 1, wherein the solid oxide fuel cell module is provided with a heat recovery system utilizing the heat recovered from said fuel side burner by said cooling means for supplying an exhaust heat recovery boiler so as to drive a vaporizing type refrigerator.

11. A solid oxide fuel cell module as claimed in claim 1, wherein the solid oxide fuel cell module is provided with a heat recovery system utilizing the heat recovered from said fuel side burner by said cooling means for supplying to a turbine so as to drive a power generator.

12. A solid oxide fuel cell module as claimed in claim 1, wherein the solid oxide fuel cell module is provided with a heat recovery system utilizing the heat recovered from said fuel side burner by said cooling means as a heat source for reforming a fuel supplied to the fuel container of said module or generating a water vapor.

13. A solid oxide fuel cell module comprising:
a cell container storing a plurality of unit cells;
a fuel container introducing a fuel such as a hydrogen or the like and an oxidizer container introducing an oxidizer such as an oxygen or the like, which are arranged in such a manner as to sandwich the cell container therebetween;
an oxidizer side burner heating the oxidizer within the oxidizer container;
a fuel side burner heating the fuel within said fuel container; and
a heat insulating material covering said fuel container, the cell container and the oxidizer container,
wherein the solid oxide fuel cell module comprises:
a premixing chamber arranged adjacently in an outer side of said fuel side burner, and introducing the fuel and the oxidizer of said fuel side burner so as to premix them;
a cooling piping arranged in the premixing chamber and putting a heating medium therethrough; and
a heat recovery system utilizing a heat recovered via the heating medium as a heat and/or a power source.

14. A control method of a solid oxide fuel cell module comprising:
a step of supplying a fuel to a fuel container from an external portion;
a step of heating the fuel within said fuel container by a fuel side burner;
a step of supplying an oxidizer to an oxidizer container from an external portion;
a step of heating the oxidizer within said oxidizer container by an oxidizer side burner; and
a step of reacting the heated fuel from said fuel container with the heated oxidizer from said oxidizer container within the cell container storing a plurality of unit cells so as to pick up an electricity,
wherein said fuel side burner is provided with a cooling step of keeping a temperature of the fuel within said fuel container within a predetermined range.

15. A control method of a solid oxide fuel cell module as claimed in claim 14, wherein the control method further comprises a step of mixing the fuel and the air introduced to the burner main body of said fuel side burner in the burner fuel premixing chamber, and said cooling step cools said burner fuel premixing chamber.

16. A control method of a solid oxide fuel cell module as claimed in claim 14, wherein the control method further comprises a step of mixing the fuel and the air introduced to the burner main body of said fuel side burner in the burner fuel premixing chamber, and said cooling step cools said burner main body.

17. A control method of a solid oxide fuel cell module as claimed in claim 14, wherein said cooling step is provided with a flow path of a heating medium passing through the burner main body of said fuel side burner.

18. A control method of a solid oxide fuel cell module as claimed in claim 14, wherein the control method further comprises a heat recovery step of recovering a heat from a heating medium heated by said cooling step.

19. A control method of a solid oxide fuel cell module as claimed in claim 18, wherein said heat recovery step recovers the heat from the heating medium heated by said cooling step by using a heat exchanger.

20. A control method of a solid oxide fuel cell module as claimed in claim 17, wherein said cooling step employs a water, an air or an inert gas as the heating medium.
